(19) United States
(12) Patent Application Publication
(10) Pub. No.: US 2009/0080740 A1
(43) Pub. Date: Mar. 26, 2009

(54) Automatic Lesion Detection and Characterization Using Generative Model of Enhancement Dynamics in Breast MR

(75) Inventors: Yoshihisa Shinagawa, Downingtown, PA (US); Gerardo Hermosillo Valadez, West Chester, PA (US)

Correspondence Address: SIEMENS CORPORATION;INTELLECTUAL PROPERTY DEPARTMENT, 170 WOOD AVENUE SOUTH, ISELIN, NJ, 08830, US

(73) Assignee: Siemens Medical Solutions USA, Inc., Malvern, PA (US)

(21) Appl. No.: 12/205,114

(22) Filed: Sep. 5, 2008

Related U.S. Application Data
(60) Provisional application No. 60/971,378, filed on Sep. 11, 2007.

(51) Int. Cl. G06K 9/00

(52) U.S. Cl. 382/131

(57) ABSTRACT

A method for automatic detection of lesions within MR images includes administering a magnetic contrast agent into a subject. A sequence of MR images are acquired at predetermined intervals of time. One or more regions of suspicion are automatically identified within the MR images. A bidirectional exchange of the magnetic contrast agent between each compartment and its neighboring compartment is monitored for each compartment within each region of suspicion. Each region of suspicion is characterized based on the bidirectional exchange between each of its compartments and their neighboring compartments.

### CROSS-REFERENCE TO RELATED APPLICATION

The present application is based on provisional application Ser. No. 60/971,378 filed Sep. 11, 2007, the entire contents of which are herein incorporated by reference.

### BACKGROUND OF THE INVENTION

1. Technical Field

The present disclosure relates to lesion detection in breast MR and, more specifically, to automatic lesion detection and characterization using generative model of enhancement dynamics in breast MR.

2. Discussion of Related Art

Computer aided diagnosis (CAD) is the process of using computer vision systems to analyze medical image data and make a determination as to what regions of the image data are potentially problematic. Some CAD techniques then present these regions of suspicion to a medical professional such as a radiologist for manual review, while other CAD techniques make a preliminary determination as to the nature of the region of suspicion. For example, some CAD techniques may characterize each region of suspicion as a lesion or a non-lesion. The final results of the CAD system may then be used by the medical professional to aid in rendering a final diagnosis.

Because CAD techniques may identify lesions that may have been overlooked by a medical professional working without the aid of a CAD system, and because CAD systems can quickly direct the focus of a medical professional to the regions most likely to be of diagnostic interest, CAD systems may be highly effective in increasing the accuracy of a diagnosis and decreasing the time needed to render diagnosis. Accordingly, scarce medical resources may be used to benefit a greater number of patients with high efficiency and accuracy.

CAD techniques have been applied to the field of mammography, where low-dose x-rays are used to image a patient's breast to diagnose suspicious breast lesions. However, because mammography relies on x-ray imaging, mammography may expose a patient to potentially harmful ionizing radiation. As many patients are instructed to undergo mammography on a regular basis, the administered ionizing radiation may, over time, pose a risk to the patient. Moreover, it may be difficult to use x-rays to differentiate between different forms of masses that may be present in the patient's breast. For example, it may be difficult to distinguish between calcifications and malignant lesions.

Magnetic resonance imaging (MRI) is a medical imaging technique that uses a powerful magnetic field to image the internal structure and certain functionality of the human body. MRI is particularly suited for imaging soft tissue structures and is thus highly useful in the field of oncology for the detection of lesions.

In dynamic contrast enhanced MRI (DCE-MRI), many additional details pertaining to bodily soft tissue may be observed. These details may be used to further aid in diagnosis and treatment of detected lesions.

DCE-MRI may be performed by acquiring a sequence of MR images that span a time before magnetic contrast agents are introduced into the patient's body and a time after the magnetic contrast agents are introduced. For example, a first MR image may be acquired prior to the introduction of the magnetic contrast agents, and subsequent MR images may be taken at a rate of one image per minute for a desired length of time. By imaging the body in this way, a set of images may be acquired that illustrate how the magnetic contrast agent is absorbed and washed out from various portions of the patient's body. This absorption and washout information may be used to characterize various internal structures within the body and may provide additional diagnostic information.

Existing approaches for characterizing internal structures based on magnetic contrast absorption and washout may simply monitor the absorption of magnetic contrast from a single source and washout to a single sink without regard for how the magnetic contrast agent that is released from one portion of the internal structure is observed by a neighboring portion of the internal structure. Accordingly, existing techniques for characterizing internal structure based on magnetic contrast absorption and washout may fail to make use of all diagnostically relevant information that may be gleamed from DCE-MRI.

### SUMMARY

A method for automatic detection of lesions within MR images includes administering a magnetic contrast agent into a subject. A sequence of MR images are acquired at predetermined intervals of time. One or more regions of suspicion are automatically identified within the MR images. A bidirectional exchange of the magnetic contrast agent between each compartment and its neighboring compartment is monitored for each compartment within each region of suspicion. Each region of suspicion is characterized based on the bidirectional exchange between each of its compartments and their neighboring compartments.

Each compartment of the region of suspicion may be a single image voxel of the MR images or each compartment of the region of suspicion is a cluster of a particular number of image voxels of the MR images.

The acquired sequence of MR images may be a dynamic contrast enhanced MRI including a pre-contrast MR image and a sequence of post-contrast MR images acquired at a regular interval of time after administration of a magnetic contrast agent.

The automatic identification of the regions of suspicion may include identifying the regions of suspicion based on an absorption and washout profile of the magnetic contrast agent observed from the sequence of MR images.

The bidirectional exchange of the magnetic contrast agent between each compartment and its neighboring compartments may be monitored by analyzing a change in compartment intensity from one MR image of the sequence to the next MR image of the sequence with respect to a change in the compartment intensity of the neighboring compartments.

Each region of suspicion may be characterized based on the bidirectional exchange between each of its compartments and their neighboring compartments by comparing each exchange against a predetermined threshold value.

When more than a particular percentage of the compartments within the region of suspicion have a rate of exchange that is greater than the predetermined threshold value, the region of suspicion may be characterized as potentially malignant. Alternatively, when the compartments within the region of suspicion have a maximum rate of exchange that is greater than the predetermined threshold value, the region of suspicion may be characterized as potentially malignant

Each region of suspicion may be characterized based on the bidirectional exchange between each of its compartments and their neighboring compartments by referring to a library of known profiles.

Each region of suspicion may be characterized based on the bidirectional exchange between each of its compartments and their neighboring compartments by determining a level of heterogeneity for the region of suspicion based on the bidirectional exchange between each of its compartments and their neighboring compartments and characterizing the region of suspicion based on the level of heterogeneity.

Each region of suspicion is characterized as either benign or potentially malignant. Alternatively, or additionally, the region of suspicion may be characterized according to a BIRADS classification.

The MR images may include an image of a breast and the identified regions of suspicion may be candidate breast lesions.

A method for automatic detection of breast lesions within MR images includes receiving a dynamic contrast enhanced magnetic resonance image (DCE-MRI) including a patient's breast. One or more regions of suspicion are automatically identified within the MR images. For each voxel within each region of suspicion, a bidirectional exchange of a magnetic contrast agent between each voxel and its neighboring voxel is monitored. Each region of suspicion is characterized based on the bidirectional exchange between each of its voxels and their neighboring voxels.

The automatic identification of the regions of suspicion may include identifying the regions of suspicion based on an absorption and washout profile of the magnetic contrast agent observed from the DCE-MRI.

The bidirectional exchange of the magnetic contrast agent between each voxel and its neighboring compartments may be monitored by analyzing a change in compartment intensity from one MR image of the sequence to the next MR image of the sequence with respect to a change in the voxel intensity of the neighboring voxels.

Each region of suspicion may be characterized based on the bidirectional exchange between each of its voxels and their neighboring voxels by determining a level of heterogeneity for the region of suspicion based on the bidirectional exchange between each of its voxels and their neighboring voxels and characterizing the region of suspicion based on the level of heterogeneity.

A computer system includes a processor and a program storage device readable by the computer system, embodying a program of instructions executable by the processor to perform method steps for correcting for automatic detection of breast lesions within MR images. The method includes administering a magnetic contrast agent into a subject, acquiring a sequence of MR images at predetermined intervals of time, automatically identifying one or more regions of suspicion within the MR images, for each voxel within each region of suspicion, monitoring a bidirectional exchange of the magnetic contrast agent between each voxel and its neighboring voxel, and characterizing each region of suspicion based on the bidirectional exchange between each of its voxels and their neighboring voxels as either benign or a potentially malignant breast lesion.

The acquired sequence of MR images may be a dynamic contrast enhanced MRI including a pre-contrast MR image and a sequence of post-contrast MR images acquired at a regular interval of time after administration of a magnetic contrast agent.

### BRIEF DESCRIPTION OF THE DRAWINGS

A more complete appreciation of the present disclosure and many of the attendant aspects thereof will be readily obtained as the same becomes better understood by reference to the following detailed description when considered in connection with the accompanying drawings, wherein:

FIG. 1 is a flow chart illustrating a method for imaging a patient's breast using DCE-MRI and rendering a computer-aided diagnosis according to an exemplary embodiment of the present invention;

FIG. 2 is a set of graphs illustrating a correspondence between absorption and washout profiles for various BIRADS classifications according to an exemplary embodiment of the present invention;

FIG. 3 is a diagram of a voxel of a medical image within a region of suspicion;

FIG. 4 is a flow chart illustrating a method for characterizing a region of suspicion in accordance with motion flow characteristics of region of suspicion subsections according to an exemplary embodiment of the present invention; and

FIG. 5 shows an example of a computer system capable of implementing the method and apparatus according to embodiments of the present disclosure.

### DETAILED DESCRIPTION OF THE DRAWINGS

In describing exemplary embodiments of the present disclosure illustrated in the drawings, specific terminology is employed for sake of clarity. However, the present disclosure is not intended to be limited to the specific terminology so selected, and it is to be understood that each specific element includes all technical equivalents which operate in a similar manner.

Exemplary embodiments of the present invention seek to image a patient's breast using DCE-MRI techniques and then perform CAD to identify regions of suspicion that are more likely to be malignant breast lesions. By utilizing DCE-MRI rather than mammography, additional data pertaining to contrast absorption and washout may be used to accurately distinguish between benign and malignant breast masses.

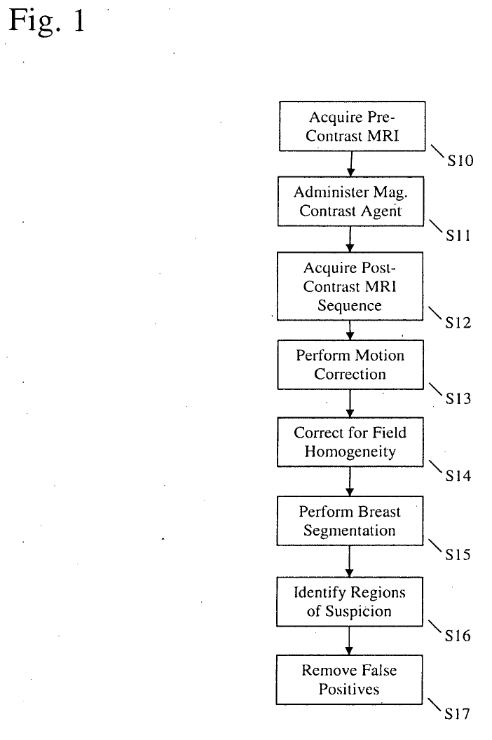

FIG. 1 is a flow chart illustrating a method for imaging a patient's breast using DCE-MRI and rendering a computer-aided diagnosis according to an exemplary embodiment of the present invention. First, a pre-contrast MRI is acquired (Step S10). The pre-contrast MRI may include an MR image taken of the patient before the magnetic contrast agent has been administered. The pre-contrast MRI may include one or more modalities. For example, both T1 and T2 relaxation modalities may be acquired.

Next, with the patient remaining as still as possible, the magnetic contrast agent may be administered (Step S11). The magnetic contrast agent may be a paramagnetic agent, for example, a gadolinium compound. The agent may be administered orally, intravenously, or by another means. The magnetic contrast agent may be selected for its ability to appear extremely bright when imaged in the T1 modality. By injecting the magnetic contrast agent into the patient's blood, vascular tissue may be highly visible in the MRI. Because malignant tumors tend to be highly vascularized, the use of the magnetic contrast agent may be highly effective for identifying regions suspected of being lesions.

Moreover, additional information may be gleamed by analyzing the way in which a region absorbs and washes out the magnetic contrast agent. For this reason, a sequence of post-contrast MR images may be acquired (Step S12). The sequence may be acquired at regular intervals in time, for example, a new image may be acquired every minute.

As discussed above, the patient may be instructed to remain as still as possible throughout the entire image acquisition sequence. Despite these instructions, the patient will most likely move somewhat from image to image. Accordingly, before regions of suspicion are identified (Step S16), motion correction may be performed on the images (Step S13).

At each acquisition, the image may be taken in the T1 modality that is well suited for monitoring the absorption and washout of the magnetic contrast agent.

Because MR images are acquired using a powerful magnetic field, subtle inhomogeneity in the magnetic field may have an impact on the image quality and may lead to the introduction of artifacts. Additionally, the level of enhancement in the post-contrast image sequence may be affected. Also, segmentation of the breast may be impeded by the inhomogeneity, as in segmentation, it is often assumed that a particular organ appears homogeneously. Accordingly, the effects of the inhomogeneous magnetic field may be corrected for within all of the acquired MR images (Step S14).

The order in which motion correction (Step S13) and inhomogeneity correction (Step S14) are performed on the MR images is not critical. All that is required is that these steps be performed after image acquisitions for each given image, and prior to segmentation (Step S15). These corrective steps may be performed for each image after each image is acquired or for all images after all images have been acquired.

After the corrective steps (Steps S13 and S14) have been performed, breast segmentation may be performed (Step S15). Segmentation is the process of determining the contour delineating a region of interest from the remainder of the image. In making this determination, edge information and shape information may be considered.

Edge information pertains to the image intensity changes between the interior and exterior of the contour. Shape information pertains to the probable shape of the contour given the nature of the region of interest being segmented. Some techniques for segmentation such as the classical watershed transformation rely entirely on edge information. Examples of this technique may be found in L. Vincent and P. Soille, “Watersheds in digital spaces: An efficient algorithm based immersion simulations” IEEE Trans. PAMI, 13(6):583-589, 1991, which is incorporated by reference. Other techniques for segmentation rely entirely on shape information. For example, in M. Kass, A. Witkin, and D. Terzopoulous, “Snakes—Active contour models” Int J Comp Vis, 1(4): 321-331, 1987, which is incorporated by reference, a calculated internal energy of the curvature is regarded as a shape prior although its weight is hard-coded and not learned through training. In A. Tsai, A. Yezzi, W. Wells, C. Tempany, D. Tucker, A. Fan, and W. E. Grimson, “A shape-based approach to the segmentation of medical imagery using level sets” IEEE Trans. Medical Imaging, 22(2): 137-154, 2003, which is incorporated by reference, the shape prior of signed distance representations called eigenshapes is extracted by Principal Component Analysis (PCA). When the boundary of an object is unclear and/or noisy, the shape prior is used to obtain plausible delineation.

When searching for lesions in the breast using DCE-MRI, internal structures such as the pectoral muscles that are highly vascularized may light up with the application of the magnetic contrast agent. Thus, the pectoral muscles, and other such structures may make location of breast lesions more difficult. Accordingly, by performing accurate segmentation, vascularized structures that are not associated with the breast tissue may be removed from consideration thereby facilitating fast and accurate detection of breast lesions.

After segmentation has been performed (Step S15), the breast tissue may be isolated and regions of suspicion may be automatically identified within the breast tissue region (Step S16). A region of suspicion is a structure that has been determined to exhibit one or more properties that make it more likely to be a breast lesion than the regions of the breast tissue that are not determined to be regions of suspicion. Detection of the region of suspicion may be performed by systematically analyzing a neighborhood of voxels around each voxel of the image data to determine whether or not the voxel should be considered part of a region of suspicion. This determination may be made based on the acquired pre-contrast MR image as well as the post-contrast MR image. Such factors as size and shape may be considered.

Moreover, the absorption and washout profile of a given region may be used to determine whether the region is suspicious. This is because malignant tumors tend to show a rapid absorption followed by a rapid washout. This and other absorption and washout profiles can provide significant diagnostic information.

Breast imaging reporting and data systems (BIRADS) is a system that has been designed to classify regions of suspicion that have been manually detected using conventional breast lesion detection techniques such as mammography and breast ultrasound. Under this approach, there are six categories of suspicious regions. Category 0 indicates an incomplete assessment. If there is insufficient data to accurately characterize a region, the region may be assigned to category 0. A classification as category 0 generally implies that further imaging is necessary. Category 1 indicates normal healthy breast tissue. Category 2 indicates benign or negative. In this category, any detected masses such as cysts or fibroadenomas are determined to be benign.

Category 3 indicates that a region is probably benign, but additional monitoring is recommended. Category 4 indicates a possible malignancy. In this category, there are suspicious lesions, masses or calcifications and a biopsy is recommended. Category 5 indicates that there are masses with an appearance of cancer and biopsy is necessary to complete the diagnosis. Category 6 is a malignancy that has been confirmed through biopsy.

Exemplary embodiments of the present invention may be able to characterize a given region according to the above BRADS classifications based on the DCE-MRI data. To perform this categorization, the absorption and washout profile, as gathered from the post-contrast MRI sequence, for each given region may be compared against a predetermined understanding of absorption and washout profiles.

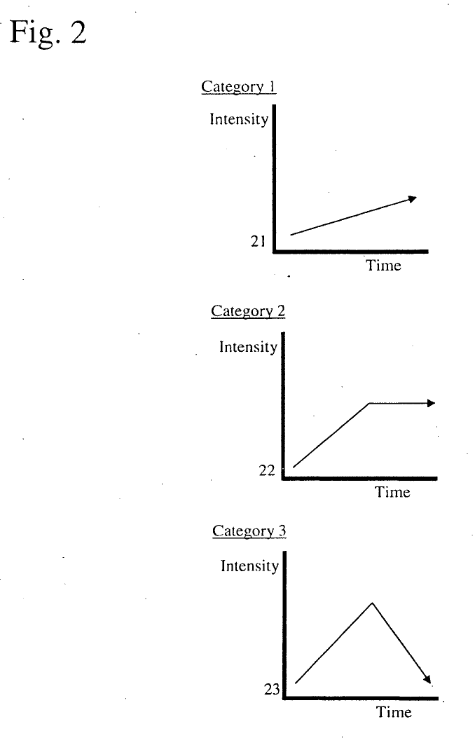

FIG. 2 is a set of graphs illustrating a correspondence between absorption and washout profiles for various BIRADS classifications according to an exemplary embodiment of the present invention. In the first graph 21, the T1 intensity is shown to increase over time with little to no decrease during the observed period. This behavior may correspond to a gradual or moderate absorption with a slow washout. This may be characteristic of normal breast tissue and accordingly, regions exhibiting this profile may be classified as category 1.

In the next graph 22, the T1 intensity is shown to increase moderately and then substantially plateau. This behavior may correspond to a moderate to rapid absorption followed by a slow washout. This may characterize normal breast tissue or a benign mass and accordingly, regions exhibiting this profile may be classified as category 2.

In the next graph 23, the T1 intensity is shown to increase rapidly and then decrease rapidly. This behavior may correspond to a rapid absorption followed by a rapid washout. While this behavior may not establish a malignancy, it may raise enough suspicion to warrant a biopsy, accordingly, regions exhibiting this profile may be classified as category 3.

Other absorption and washout profiles may be similarly established for other BIRADS categories. In this way, DCE-MRI data may be used to characterize a given region according to the BIRADS classifications. This and potentially other criteria, such as size and shape, may thus be used to identify regions of suspicion (Step S116).

After regions of suspicion have been identified, false positives may be removed (Step S17). As described above, artifacts such as motion compensation artifacts, artifacts cause by magnetic field inhomogeneity, and other artifacts, may lead to the inclusion of one or more false positives. Exemplary embodiments of the present invention and/or conventional approaches may be used to reduce the number of regions of suspicion that have been identified due to an artifact, and thus false positives may be removed. Removal of false positives may be performed by systematically reviewing each region of suspicion multiple times, each time for the purposes of removing a particular type of false positive. Each particular type of false positive may be removed using an approach specifically tailored to the characteristics of that form of false positive. Examples of such approaches are discussed in detail below.

After false positives have been removed (Step S17), the remaining regions of suspicion may be presented to the medical practitioner for further review and consideration. For example, the remaining regions of interest may be highlighted within a representation of the medical image data. Quantitative data such as size and shape measurements and/or BIRADS classifications may be presented to the medical practitioner along with the highlighted image data. The presented data may then be used to determine a further course of testing or treatment. For example, the medical practitioner may use the presented data to order a biopsy or refer the patient to an oncologist for treatment.

However, absorption and washout of magnetic contrast within the internal structure of a patient may operate in a complex manner. This complexity may be caused, at least in part, due to the way in which magnetic contrast absorbed and then released from one portion of the internal structure is absorbed and later released from an adjacent portion of the internal structure. In this way, magnetic contrast agent may be passed around in an elaborate pattern from the moment the magnetic contrast agent is introduced until it is completely dissipated.

This elaborate pattern of absorption and release may provide a higher level of diagnostic information than simply monitoring the absorption of the magnetic contrast agent from a single source and release to a single sink. This additional diagnostic information may then be used to characterize a region of suspicion with a greater degree of accuracy than by single source, single sink monitoring.

Exemplary embodiments of the present invention may make use of the fact be carried into and out of lesions through blood vessels. The magnetic contrast agent that is introduced into the vicinity of the lesions, having molecules that are too large to enter the cells, may enter the region known as extra-vascular extracellular space (EES). Accordingly, under the single source, single sink approach, the blood vessels may be seen as source and the ESS as sink, or visa versa.

Exemplary embodiments of the present invention may also go beyond the single source, single sink approach and may consider the kinetic heterogeneity of lesions. According to this approach, it is understood that within a potentially malignant lesion, there may be a number of regions having different rates of exchange of the magnetic contrast agent. Accordingly, by identifying that a region of suspicion contains a plurality of subsections that each have different exchange rates, it can be known that the region of suspicion in question is of a higher likelihood for being malignant.

Additionally, exemplary embodiments of the present invention may also analyze the manner in which these subsections exchange magnetic contrast between them, where one such subsection may act as source, and another as sink. In fact, exchange between neighboring subsections may be bidirectional such that each may act as both source and sink at the same time. This manner of interaction between neighboring subsections may be used to generate a set of motion flow characteristics for a particular region of interest and these motion flow characteristics may, in turn, be used to characterize the nature of the region of suspicion, for example, as benign or malignant or for example, to characterize the type of malignancy.

In developing the set of motion flow characteristics, it may be assumed that each voxel of the medical image within the region of suspicion may be a subsection and that each voxel may have six (6) neighboring voxels. Exchange of magnetic contrast may occur bidirectional between the voxel and each of the six (6) neighboring voxels. By characterizing all twelve (12) of these exchanges, the motion flow characteristics of the voxel may be well understood.

Alternatively, a different number of voxels may be considered within the neighborhood. The greater the neighborhood, the more accurate the analysis could potentially be, however, the more complex the calculations may become. For example, the neighborhood may include twenty-six (26) voxels, in which case there would be fifty-two (52) rates of exchange contributing to the motion flow characteristics.

The exchange of magnetic contrast agent between neighboring voxels may be understood by the rate in which voxel intensity of each voxel changes from image to image within the DCE-MRI with relation to neighboring voxels. For example, where a voxel appears brightly lit in one image and its neighboring voxels appear more dimly lit, and then in the next image, the voxel appears more dimly lit and the neighboring voxels more brightly lit, it may be understood that the magnetic contrast has flowed from the voxel to its neighbors.

The values of the exchange rates between neighboring voxels may be calculated in the general case by solving a system of linear equations that represent the change in voxel intensity for each voxel. In the system of linear equations, differential equations may be approximated by finite differences. Where there are n voxels within the region of suspicion, and m blood vessels, there may be 12n+m parameters to take into account. On the other hand, there may be Tn observed known voxel intensities where T is the number of images in the DCE-MRI sequence. Where it is necessary to utilize additional images, T images may be created from the actual sequence of DCE-MRI images by interpolation. The maximum enhancement within the lesion may also be tracked to further reduce the complexity of the linear system. Finally, malignancy may be associated with the heterogeneity represented by the diversity of the exchange rates of the voxels.

The flow of magnetic contrast between neighboring voxels may also be ascertained, for example, by tracking voxels that attain maximum exchange rates. For a malignant lesion, such voxels may be located at the periphery or along lines inside the region of interest.

Alternatively, or in addition to one or more of the approaches discussed above, iso-lines representing the amount of exchange quantity may be calculated and the change in the iso-lines may be monitored as time progresses. These lines may behave as ripples on the surface of water where a stone has been thrown, as they may move, bend and otherwise change over time. The movement characteristics of these iso-lines may be indicative of whether the region of suspicion is benign or malignant. For example, if the ripple movement of the iso-lines are centrifugal, the region of interest may be benign. When the ripple movement of the iso-lines are centripetal, the region of interest may be potentially malignant.

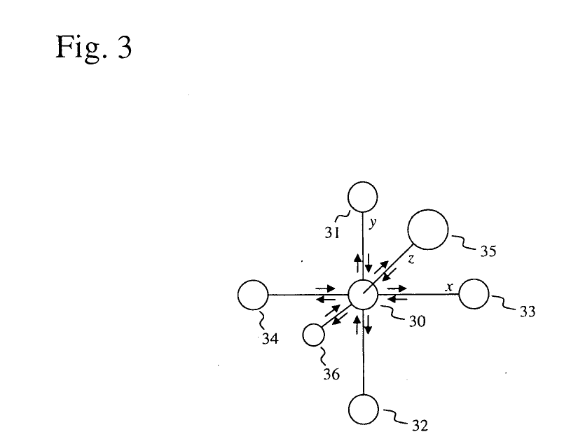

FIG. 3 is a diagram of a voxel 30 of a medical image within a region of suspicion. The voxel 30 may have six (6) neighbors: a neighboring voxel in the +y direction 31, a neighboring voxel in the −y direction 32, a neighboring voxel in the +x direction 33, a neighboring voxel in the −x direction 34, a neighboring voxel in the +z direction 35, and a neighboring voxel in the −z direction 36. For each neighboring voxel 31-36, the voxel 30 may have an inflow and an outflow of magnetic contrast agent, illustrated by directional arrows. Accordingly, for each voxel of the medical image data within a region of suspicion, there may be twelve (12) rates of exchange that may make up the motion flow characteristics for each voxel. Then, when the motion flow characteristics for each voxel within a particular region of suspicion is know, this information may be used to classify the region of interest as either benign or possibly malignant or as a particular type of malignancy. One or more of the voxels so analyzed may represent or be in contact with a vessel. These voxels may be identified as voxels with initial rapid enhancement. Accordingly, information pertaining to which voxels represent or are adjacent to vessels may be taken into account in characterizing the region of interest.

As described above, there may be more or less voxels characterized as neighboring voxels depending on the balance that is to be struck between accuracy and ease of calculation. Six neighboring voxels, as shown in FIG. 3, may provide a suitable balance; however, as computational resources advance, a greater number of neighboring pixels may be used.

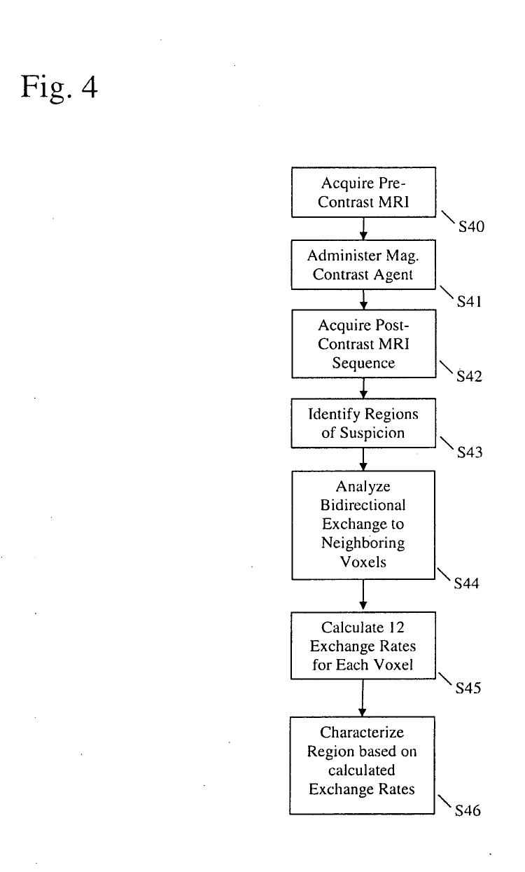

FIG. 4 is a flow chart illustrating a method for characterizing a region of suspicion in accordance with motion flow characteristics of region of suspicion subsections according to an exemplary embodiment of the present invention. As is the case above, first a pre-contrast MR image may be acquired (Step S40). Next, a magnetic contrast agent may be administered (Step S41). Then, a sequence of post contrast MR images may be acquired at predetermined intervals in time (Step S42). One or more regions of suspicion may then be identified, for example, as described in detail above with respect to FIG. 1 (Step S43).

Then, each voxel of each detected region of suspicion may be analyzed and the bidirectional rate of exchange of the magnetic contrast agent between the analyzed voxel and each of its six (6) neighboring voxels may be calculated (Step S45) to generate a set of motion flow characteristics for the region of suspicion. The motion flow characteristics may then be used to characterize the region of suspicion (Step S46). Characterization of the region of suspicion may include identifying the region of suspicion as a true lesion or as a false positive, in accordance with step S17 described above with respect to FIG. 1. Alternatively, characterization of the region of suspicion may include identifying whether the region of suspicion has an elevated risk of being malignant and/or a likely classification of the malignancy. The ultimate results may then be provided to a medical practitioner, for example, a radiologist, so that a final diagnosis may be rendered and a course of treatment devised.

Techniques for characterizing of the region of suspicion based on the set of motion flow characteristics may be either simple or complex. In the simplest case, a library of known profiles may be stored and referenced after the 12 exchange rates for each voxel have been calculated. By referencing the library, either directly, using hash values, and/or as part of an indexed search, the characterization of the region of suspicion may be known. In such a case, the library of profiles may be based on a set of training data for which the characterization of each region of suspicion has been manually determined.

In characterizing the region of suspicion, the bidirectional exchange rates may be compared against a predetermined threshold value to determine whether the region of suspicion is benign or potentially malignant.

For example, if more than a particular percentage of the voxels within the region of suspicion have an exchange rate (among the six exchange rates per voxel) above a predefined threshold, the region of suspicion may be determined to be potentially malignant.

Another example is that when a minimum of the exchange rates among all the voxels in the region of suspicion are above a particular threshold, in such a case, the region of suspicion may be determined to be potentially malignant.

Additionally, classifiers, for example, a quadratic discriminant analysis, may be trained to learn the optimum threshold. For example, a training set of exchange rates for malignant and benign sets may be provided and a threshold that separates the two sets may be found and used.

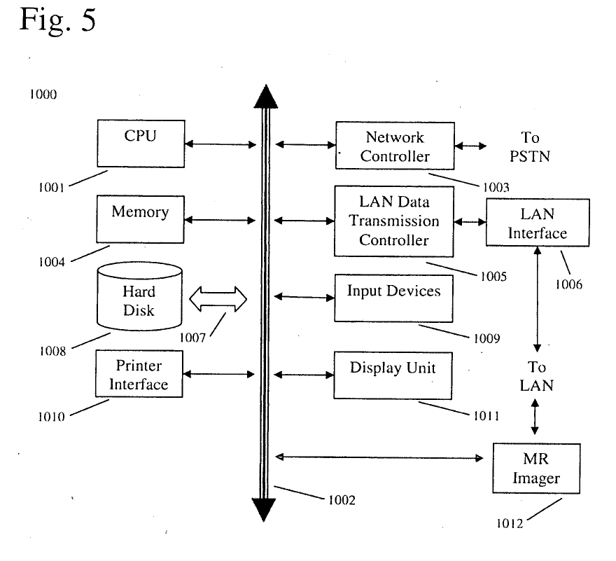

FIG. 5 shows an example of a computer system which may implement a method and system of the present disclosure. The system and method of the present disclosure may be implemented in the form of a software application running on a computer system, for example, a mainframe, personal computer (PC), handheld computer, server, etc. The software application may be stored on a recording media locally accessible by the computer system and accessible via a hard wired or wireless connection to a network, for example, a local area network, or the Internet.

The computer system referred to generally as system 1000 may include, for example, a central processing unit (CPU) 1001, random access memory (RAM) 1004, a printer interface 1010, a display unit 1011, a local area network (LAN) data transmission controller 1005, a LAN interface 1006, a network controller 1003, an internal bus 1002, and one or more input devices 1009, for example, a keyboard, mouse etc. As shown, the system 1000 may be connected to a data storage device, for example, a hard disk, 1008 via a link 1007. A MR imager 1012 may be connected to the internal bus 1002 via an external bus (not shown) or over a local area network.

Exemplary embodiments described herein are illustrative, and many variations can be introduced without departing from the spirit of the disclosure or from the scope of the appended claims. For example, elements and/or features of different exemplary embodiments may be combined with each other and/or substituted for each other within the scope of this disclosure and appended claims.

What is claim is:

1. A method for automatic detection of lesions within MR images, comprising:
administering a magnetic contrast agent into a subject;
acquiring a sequence of MR images at predetermined intervals of time;
automatically identifying one or more regions of suspicion within the MR images;
for each compartment within each region of suspicion, monitoring a bidirectional exchange of the magnetic contrast agent between each compartment and its neighboring compartment; and
characterizing each region of suspicion based on the bidirectional exchange between each of its compartments and their neighboring compartments.

2. The method of claim 1, wherein each compartment of the region of suspicion is a single image voxel of the MR images.

3. The method of claim 1, wherein each compartment of the region of suspicion is a cluster of a particular number of image voxels of the MR images.

4. The method of claim 1, wherein the acquired sequence of MR images is a dynamic contrast enhanced MRI including a pre-contrast MR image and a sequence of post-contrast MR images acquired at a regular interval of time after administration of a magnetic contrast agent.

5. The method of claim 1, wherein the automatic identification of the regions of suspicion includes identifying the regions of suspicion based on an absorption and washout profile of the magnetic contrast agent observed from the sequence of MR images.

6. The method of claim 1, wherein the bidirectional exchange of the magnetic contrast agent between each compartment and its neighboring compartments is monitored by analyzing a change in compartment intensity from one MR image of the sequence to the next MR image of the sequence with respect to a change in the compartment intensity of the neighboring compartments.

7. The method of claim 1, wherein each region of suspicion is characterized based on the bidirectional exchange between each of its compartments and their neighboring compartments by comparing each exchange against a predetermined threshold value.

8. The method of claim 7, wherein when more than a particular percentage of the compartments within the region of suspicion have a rate of exchange that is greater than the predetermined threshold value, the region of suspicion is characterized as potentially malignant.

9. The method of claim 7, wherein when the compartments within the region of suspicion have a maximum rate of exchange that is greater than the predetermined threshold value, the region of suspicion is characterized as potentially malignant

10. The method of claim 1, wherein each region of suspicion is characterized based on the bidirectional exchange between each of its compartments and their neighboring compartments by referring to a library of known profiles.

11. The method of claim 1, wherein each region of suspicion is characterized based on the bidirectional exchange between each of its compartments and their neighboring compartments by determining a level of heterogeneity for the region of suspicion based on the bidirectional exchange between each of its compartments and their neighboring compartments and characterizing the region of suspicion based on the level of heterogeneity.

12. The method of claim 1, wherein each region of suspicion is characterized as either benign or potentially malignant.

13. The method of claim 1, wherein each region of suspicion is characterized according to a BIRADS classification.

14. The method of claim 1, wherein the MR images include an image of a breast and the identified regions of suspicion are candidate breast lesions.

15. A method for automatic detection of breast lesions within MR images, comprising:
receiving a dynamic contrast enhanced magnetic resonance image (DCE-MRI) including a patient's breast;
automatically identifying one or more regions of suspicion within the MR images;
for each voxel within each region of suspicion, monitoring a bidirectional exchange of a magnetic contrast agent between each voxel and its neighboring voxel; and
characterizing each region of suspicion based on the bidirectional exchange between each of its voxels and their neighboring voxels.

16. The method of claim 15, wherein the automatic identification of the regions of suspicion includes identifying the regions of suspicion based on an absorption and washout profile of the magnetic contrast agent observed from the DCE-MRI.

17. The method of claim 15, wherein the bidirectional exchange of the magnetic contrast agent between each voxel and its neighboring compartments is monitored by analyzing a change in compartment intensity from one MR image of the sequence to the next MR image of the sequence with respect to a change in the voxel intensity of the neighboring voxels.

18. The method of claim 12, wherein each region of suspicion is characterized based on the bidirectional exchange between each of its voxels and their neighboring voxels by determining a level of heterogeneity for the region of suspicion based on the bidirectional exchange between each of its voxels and their neighboring voxels and characterizing the region of suspicion based on the level of heterogeneity.

19. A computer system comprising:
a processor; and
a program storage device readable by the computer system, embodying a program of instructions executable by the processor to perform method steps for correcting for automatic detection of breast lesions within MR images, the method comprising:
administering a magnetic contrast agent into a subject;
acquiring a sequence of MR images at predetermined intervals of time;
automatically identifying one or more regions of suspicion within the MR images;
for each voxel within each region of suspicion, monitoring a bidirectional exchange of the magnetic contrast agent between each voxel and its neighboring voxel; and
characterizing each region of suspicion based on the bidirectional exchange between each of its voxels and their neighboring voxels as either benign or a potentially malignant breast lesion.

20. The computer system of claim 17, wherein the acquired sequence of MR images is a dynamic contrast enhanced MRI including a pre-contrast MR image and a sequence of post-contrast MR images acquired at a regular interval of time after administration of a magnetic contrast agent.
